(19) United States
(12) Patent Application Publication
(10) Pub. No.: US 2021/0158196 A1
(43) Pub. Date: May 27, 2021

(54) NON-STATIONARY DELAYED BANDITS WITH INTERMEDIATE SIGNALS

(71) Applicant: DeepMind Technologies Limited, London (GB)

(72) Inventors: Claire Vernade, London (GB); András György, London (GB); Timothy Arthur Mann, Harpenden (GB)

(21) Appl. No.: 17/103,843

(22) Filed: Nov. 24, 2020

Related U.S. Application Data
(60) Provisional application No. 62/940,179, filed on Nov. 25, 2019.

(51) Int. Cl. G06N 7/00; G06N 7/08; G06N 20/00

(52) U.S. Cl. CPC G06N 7/005; G06N 20/00; G06N 7/08

(57) ABSTRACT

Methods, systems, and apparatus, including computer programs encoded on computer storage media, of selecting actions from a set of actions to be performed in an environment. One of the methods includes, at each time step: maintaining count data; determining, for each action, a respective current transition probability distribution that includes a respective current transition probability for each of the intermediate signals that represents an estimate of a current likelihood that the intermediate signal will be observed if the action is performed; determining, for each intermediate signal, a respective reward estimate that is an estimate of a reward that will be received as a result of the intermediate signal being observed; determining, from the respective current transition probability distributions and the respective reward estimates, a respective action score for each action; and selecting an action to be performed based on the respective action scores.

### CROSS-REFERENCE TO RELATED APPLICATION

This application claims priority to U.S. Provisional Application No. 62/940,179, filed on Nov. 25, 2019. The disclosure of the prior application is considered part of and is incorporated by reference in the disclosure of this application.

### BACKGROUND

This specification relates to multi-armed bandits.

In a multi-armed bandits scenario, an agent iteratively selects actions to be performed in an environment from a set of possible actions. In response to each action, the agent receives a reward that measures the quality of the selected action. The agent attempts to select actions that maximize expected rewards received in response to performing the selected action.

### SUMMARY

This specification describes a system implemented as computer programs on one or more computers in one or more locations that selects actions to be performed using a non-stationary, delayed bandit scheme.

Particular embodiments of the subject matter described in this specification can be implemented so as to realize one or more of the following advantages.

Online recommender systems often face long delays in receiving feedback, especially when optimizing for some long-term metrics. In particular, delays occur when the reward that measures the quality of actions selected by the recommender system is only available many time steps after the actions have been selected.

While mitigating the effects of delays in learning can be compensated for in stationary environments, the problem becomes much more challenging when the environment changes over time, i.e., when the distribution of rewards that can be expected to be received in response to receiving any given action changes over time.

In fact, if the timescale of the change is comparable to the delay in receiving rewards, it is impossible for many existing techniques to learn about the environment, since the available observations are already obsolete once the reward is received.

The techniques described in this specification address these deficiencies and allow effective learning (and, therefore effective action selection) in dynamic environments with delayed rewards by making use of intermediate signals that are available with no delay or with a delay that is small relative to the delay with which the rewards are received. In particular, the described techniques leverage the fact that, given those signals, the long-term behavior of the system is stationary or changes very slowly. In particular, by decomposing the action selection problem into (i) estimating a changing probability of receiving any given intermediate signal in response to a given action and (ii) estimating a stationary probability of receiving a given reward after the given intermediate signal is received, the system can effectively select actions even in the presence of delayed rewards and a non-stationary environment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example bandit system.

FIG. 1B shows an example of an environment with intermediate signals and delayed rewards.

FIG. 2 is a flow diagram of an example process for selecting an action at a given time step.

FIG. 3 is a flow diagram of another example process for computing an action score for an action.

### DETAILED DESCRIPTION

This specification generally describes a system that repeatedly selects actions to be performed in an environment.

Each action is selected from a predetermined set of actions and the system selects actions in an attempt to maximize the rewards received in response to the selected actions.

Generally, the rewards are numeric values that measure the quality of the selected actions. In some implementations, the reward for each action is either zero or one, while in other implementations each reward is a value drawn from a continuous range between a lower bound reward value and an upper bound reward value.

More specifically, the rewards that are received for any given action are delayed in time relative to the time at which the action is selected (and performed in the environment). For example, the rewards might measure some long-term objective that can only be satisfied or is generally only satisfied a significant amount of time after the action is performed.

However, an intermediate signal can be observed from the environment after the action is performed.

An intermediate signal is data describing the state of the environment that is received relatively shortly after an action is performed, e.g.., at the same time step or at the immediately following time step, and that provides an indication of what the reward for the action selection may turn out to be.

In particular, after an action is performed, the environment assumes an intermediate state that can be described by one of a discrete set of intermediate signals. After some time delay, a reward is received that is dependent on what the intermediate signal was.

In some cases, the actions are recommendations of content items, e.g., books, videos, advertisements, images, search results, or other pieces of content.

In these cases, the reward values measure the quality of the recommendation as measured by a long-term objective and the intermediate signals may be indications of an initial, short-term interaction with the content item.

For example, when the content items are books, the reward values may be based on whether the user's e-reader application indicates that the user read more than a threshold amount of the book. The intermediate signals, on the other hand, can indicate whether the user downloaded the e-book.

As another example, when the content items are advertisements, the reward values may be based on whether a conversion event occurs as a result of the advertisement being presented. The intermediate signals, on the other hand, can indicate whether a click through event occurred, i.e., whether the user clicked on or otherwise selected the presented advertisement.

As another example, when the content items are software applications, e.g., mobile applications, the reward values may be based on a measure of how frequently a user uses the software application after a significant amount of time, e.g., a week or a month. The intermediate signals, on the other hand, can indicate whether the user downloaded the software application from an app store..

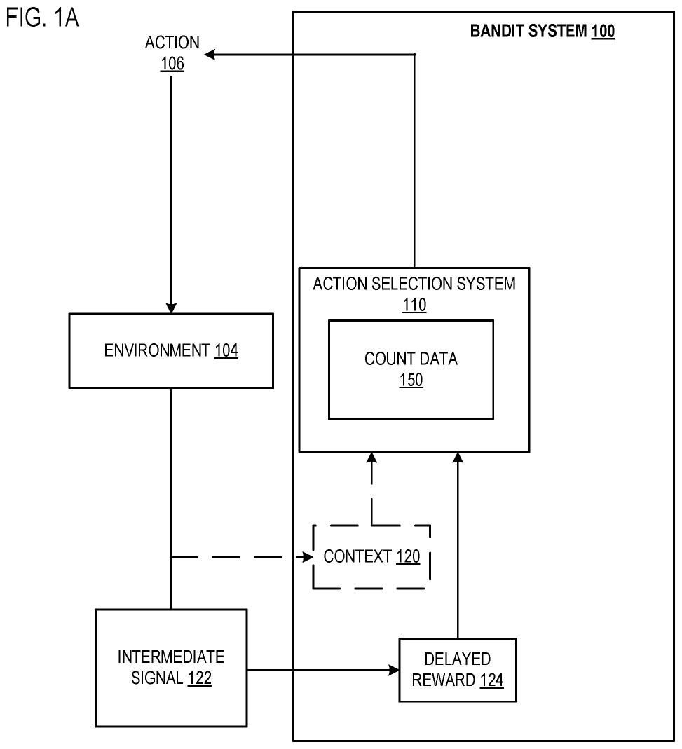

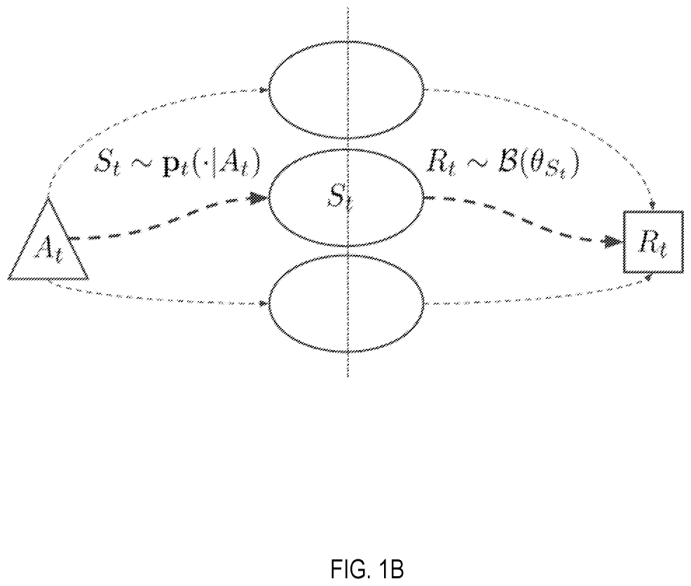

FIG. 1A shows an example bandit system 100. The bandit system 100 is an example of a system implemented as computer programs on one or more computers in one or more locations in which the systems, components, and techniques described below are implemented.

The system 100 repeatedly, i.e., at each of multiple time steps, selects an action 106 to be performed, e.g., by the system 100 or by another system, in an environment 104. For example, as described above, the actions can be content item recommendations to be made to a user in an environment, i.e., in a setting for the content item recommendation, e.g., on a webpage or in a software application.

In some cases, the system 100 selects actions in response to received context inputs 120, e.g., a feature vector or other data characterizing the current time step. In the content item recommendation setting, the data generally includes data describing the circumstances in which the content item is going to be recommended, e.g., any of the current time, attributes of the user device of the user to whom the recommendation will be displayed, attributes of previous content items that been recommended to the user and user responses to those previous content items, and attributes of the setting in which the content item is going to be placed.

Performance of each selected action 106 generally causes the system 100 to receive a reward 124 from the environment 104.

Generally, the reward 124 is a numerical value that represents a quality of the selected action 106.

In some implementations, the reward 124 for each action 106 is either zero or one, i.e., indicates whether the action was successful or not, while in other implementations the reward 124 is a value drawn from a continuous range between a lower bound reward value and an upper bound reward value, i.e., represents the quality of the action 106 as a value from a continuous range rather than as a binary value. In particular, the action selection system 110 selects actions in an attempt to maximize the rewards received in response to the selected actions.

However, the environment 104 is an environment that provides the rewards 124 with a significant delay, i.e., a delay of multiple time steps, after the corresponding action 106 has been performed. Therefore, the rewards 124 are referred to as “delayed rewards.”

Instead, after an action 106 is performed, the system 100 receives (or “observes”) an intermediate signal 122 from the environment 104. An intermediate signal 124 is data that (i) is received after an action 106 is performed but with no delay or with a delay that is small relative to the delay that occurs before the reward is received, i.e., within a threshold number of time steps of the action 106 being performed, e.g., at the same time step or at the immediately following time step, and (ii) that provides an indication of what the reward for the action selection may turn out to be. In other words, the reward 124 received in response to a given action selection may be delayed in time relative to the action selection but depends on the intermediate observation 122 that is received with no delay or a relatively small delay after the action selection is made.

FIG. 1B shows an example of an environment with intermediate signals and delayed rewards.

In the example of FIG. 1B, at time step t, an action Aₜ is performed and one of a discrete set of intermediate signals S is subsequently observed.

In particular, after action Aₜ is performed, an intermediate signal can be considered to be sampled from a time-varying probability distribution pₜ, depending on Aₜ, that assigns a respective transition probability to each intermediate signal in the discrete set.

In the example of FIG. 1B, an intermediate signal Sₜ is observed.

Multiple time steps later, a reward Rₜ for the action Aₜ is received. Given the intermediate signal Sₜthe probability distribution B over possible rewards is approximately independent of the action Aₜ. In other words, once the intermediate signal Sₜ is observed, the same probability is assigned to each possible reward no matter what action was selected that caused the intermediate signal Sₜ to be observed.

Moreover, as described above, the environment is non-stationary. In particular, the probability distribution pt over intermediate signals for any given action can change over time because certain aspects of the environment, e.g., how users react to the actions that are selected by the system, change over time.

However, the probability distribution B is stationary and does not change with time. That is, once an intermediate signal Sₜ is observed, while the actual probability distribution β may not be known to the system, it does not change with time or changes very slowly.

While the exact probability distribution pₜ and B are not known to the system 100 at any given time, the system 100 selects actions in an attempt to maximize expected rewards by estimating these distributions and using the estimates to select actions.

Returning to the description of FIG. 1A, the system 100 selects actions to account for (i) the non-stationary nature of the intermediate signals 122 and (ii) the delayed rewards 124.

In particular, an action selection engine 110 maintains count data 150 and uses the maintained count data 150 to select actions 122 that optimize expected rewards, i.e., that optimize the expected delayed reward 124 to be received in response to performing an action given the current transition probability distribution and the stationary reward distribution.

More specifically, the action selection engine 110 maintains, in the count data 150 and for each action in the set of actions, counts of how frequently each of the intermediate signals 122 have been received in response to the action being performed. The engine 110 also maintains, in the count data 150 and for each of the possible intermediate signals 122, counts of rewards that have been received after the intermediate signal was observed.

The action selection engine 110 then uses the count data 150 to estimate transition probabilities for the intermediate signals and to estimate reward distributions for the intermediate signals and uses these estimates to select actions.

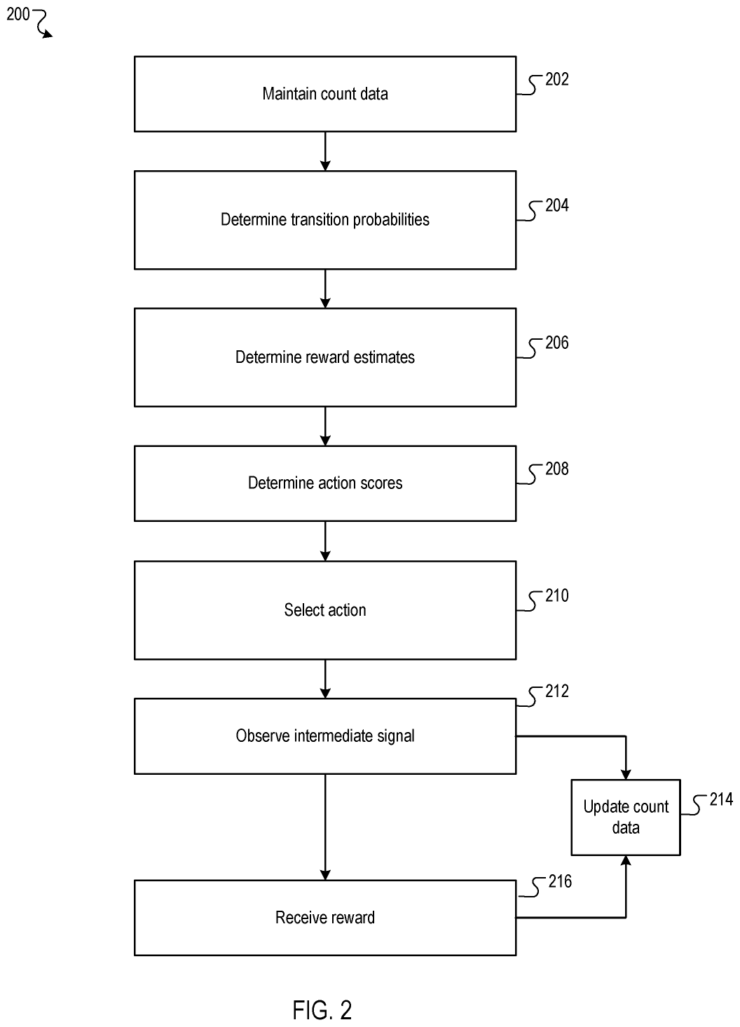

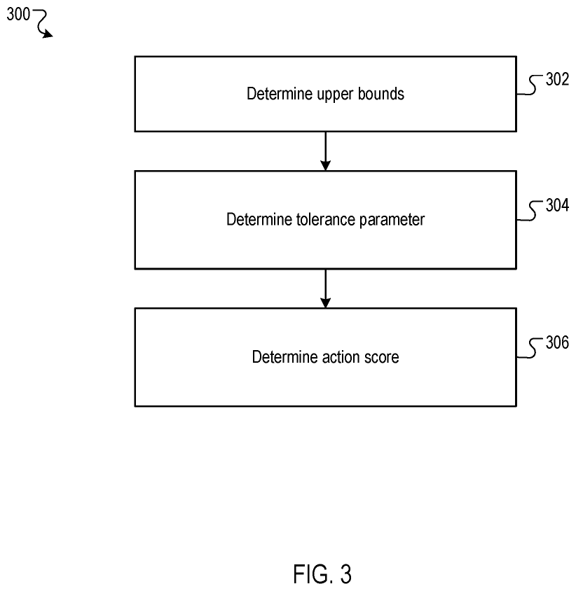

Selecting actions will be described in more detail below with reference to FIGS. 2-3.

FIG. 2 is a flow diagram of an example process 200 for selecting an action at a current time step. For convenience, the process 200 will be described as being performed by a system of one or more computers located in one or more locations. For example, a bandit system, e.g., the bandit system 100 of FIG. 1A, appropriately programmed, can perform the process 200.

In particular, the system can perform the process 200 at each time step in a sequence of time steps to repeatedly select actions to be performed in the environment.

The system maintains count data (step 202).

As described above, the count data includes two different kinds of counts: counts of intermediate signals, and counts of rewards.

In particular, as described above, the transition probabilities are non-stationary. Therefore, for each action, the system maintains a respective windowed count of each of the intermediate signals.

For a given action, the windowed count for any given intermediate signal is a count of how many times the given intermediate signal was observed (i) in response to the given action being performed and (ii) within a recent time window of the current time step, i.e., within the most recent W time steps, where W is a fixed constant.

By maintaining windowed counts that only track “recent” action selections, the system can account for the non-stationary nature of the transition probabilities, as will be described in more detail below.

As described above, the rewards are observed with some delay, and their distributions are (i) independent of actions given intermediate signals and (ii) stationary.

Therefore, the system maintains, for each particular intermediate signal and for each of a set of possible rewards, a respective count of rewards that have been received after the particular intermediate signal has been observed, i.e., a respective count of rewards that satisfy the following condition: the reward was received as a result of an action being performed that also resulted in the particular intermediate signal being observed. In other words, a reward satisfies the condition if it is received as a consequence of an action selection that also resulted in the particular intermediate signal being observed.

Because the rewards are stationary, there is no need to window this count and the count is over a longer time window that generally includes many more time steps than the recent time window counts used for the intermediate signals. For example, the longer time window can include all of the earlier time steps up to the most recent time step that satisfy the following condition: a reward has already been received for the action performed for the time. That is, because the rewards are delayed, there will be no data available for at least some of the time steps in the most recent time window, i.e., because rewards have not yet been received in response to the intermediate signals observed for actions selected at those time steps.

The system also maintains a delayed count for each intermediate signal that is a count of how many times the intermediate signal has been observed in the longer time window.

Note that, as above, because rewards are delayed and the longer time window does not include the most recent time steps, this delayed count will generally be less than the total number of times the intermediate signal has been observed over all of the earlier time steps.

In some cases, in order to seed the count data, the system can perform each action a threshold amount of times prior to selecting actions using the techniques described below, e.g., by selecting actions uniformly at random without replacement until each action is selected once.

The system determines, for each action and from the count data, an estimate of the current transition probability distribution over the intermediate signals (step 204). The estimate of the current transition probability distribution include a respective current transition probability estimate for each intermediate signal.

In particular, for each action and for each intermediate signal in the set, the system determines an estimate of the current transition probability for the action that represents how likely it is that the intermediate signal will be observed if the action is selected at the given time step.

In particular, for any particular action, the system can compute the transition probability estimate for a particular intermediate signal as the ratio of (i) the count of rewards received given that the particular intermediate signal was observed and (ii) the total count of the number of times the particular intermediate signal was observed during the longer time window, i.e., the sum of the windowed counts for all of the intermediate signals given the particular action was performed.

The system determines, for each intermediate signal, a reward estimate that is an estimate of the reward that will be received if the intermediate signal is observed (step 206).

In particular, for any particular intermediate signal, the system can compute the reward estimate for the particular intermediate signal as the ratio of (i) the reward count for the particular intermediate signal over the longer time window and (ii) the delayed count of the particular intermediate signal.

The system determines, from the transition probability estimates and the reward estimate, an action score for each agent (step 208). In particular, the system uses a stochastic bandit technique to map the transition probability estimates and the reward estimates to a respective action score for each agent that estimates the (delayed) reward that will be received in response to the action being performed. While any appropriate stochastic technique can be used, a specific example of such a technique is described below with reference to FIG. 3.

The system selects one of the actions based on the action scores (step 210). For example, the system can select the action having the highest action score or can select the action in accordance with some exploration policy. An example of an exploration policy is an epsilon greedy policy in which a random action from the set is selected with probability epsilon and the action having the highest action score is selected with probability one minus epsilon.

The system receives an intermediate signal that was observed in response to the selected action being performed (step 210). As described above, the intermediate signals are observed without significant delay.

The system updates the count data (step 212). In particular, the system updates the windowed counts for the selected action, i.e., to remove the oldest time step in the recent time window from the windowed counts for all of the intermediate signals and to add one only to the windowed count for the observed intermediate signal.

The system receives a reward (step 214). Because the rewards are delayed, the received reward is in response to an action taken at an earlier time step and as a result of the intermediate signal that was observed at that earlier time step.

The system updates the count data (step 212). In particular, the system updates, for the intermediate signal that was observed at that earlier time step, the count of rewards and the delayed count for the signal without needing to update the counts for the other intermediate signals.

FIG. 3 is a flow diagram of an example process 300 for performing a stochastic bandit technique to generate an action score for a particular action. For convenience, the process 300 will be described as being performed by a system of one or more computers located in one or more locations. For example, a bandit system, e.g., the bandit system 100 of FIG. 1A, appropriately programmed, can perform the process 300.

The system can perform the process 300 for all of the actions in the set to generate a respective action score for all of the actions.

The system computes, for each intermediate signal, an upper confidence bound for the reward estimate for signal (step 302).

In particular, the system can compute an optimistic reward estimate by adding a bonus to the reward estimate that is based on the number of time steps that have already occurred, the total number of possible intermediate signals, and the delayed count for the intermediate signal over the longer time window.

As a particular example, the bonus for a signal s can satisfy:

$$\sqrt{\frac{2 log ( \frac{2 TS}{δ} )}{{N}_{t}^{D} ( s )}} ,$$

where T is a fixed time horizon of the system, S is the total number of intermediate signals, δ is a fixed constant, and Nₜ^{D} (s) is the delayed count for the intermediate signal s.

The system can then compute the upper confidence bound as the minimum of (i) the maximum possible reward and (ii) the optimistic reward estimate.

The system computes a tolerance parameter for the action (step 304). The tolerance parameter is based on the size W of the recent time window, the total number of actions K, the windowed count Nₜ^{W} (a) of the total number of times the action has been performed during the recent time window, and the total number of time steps that have already occurred.

As a particular example, the tolerance parameter for an action a can satisfy:

$$\sqrt{\frac{2 S log ( \frac{KWT}{δ} )}{{N}_{t}^{W} ( a )}} .$$

The system computes the action score for the action from the current transition probability distribution estimate for the action, the upper confidence bounds for the intermediate signals, and the tolerance parameter for the action (step 306).

In particular, the system computes the action score as the maximum expected reward given any transition probability distribution that is within the tolerance parameter of the current estimated transition probability distribution.

The optimistic estimate of the expected reward for any transition probability distribution is the sum of the respective product of, for each intermediate signal, the transition probability for the signal and the upper confidence bound for the signal.

In other words, the action score satisfies:

max{q^{T}Uₜ:∥\hat{p}ₜ(a)−q∥₁≤TP},

where q is a transition probability distribution in the set Δ_{S} of possible transition probability distributions, Uₜ is a vector of the upper confidence bounds for the intermediate signals, \hat{p}ₜ(a) is the current transition probability distribution, and TP is the tolerance parameter.

An example technique for computing this maximum expected reward is described in Jaksch, T., Ortner, R., and Auer, P. Near-optimal regret bounds for reinforcement learning. Journal of Machine Learning Research, 11(51):1563-1600, 2010.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers.

The apparatus can also be, or further include, special purpose logic circuitry, e.g., an FPGA

Attorney Docket No. 45288-0097001 (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of selecting actions from a set of actions to be performed in an environment, the method comprising, at each time step in a sequence of a plurality of time steps:
maintaining count data, the count data specifying:
(i) for each action and for each intermediate signal in a discrete set of intermediate signals, a count of how many times the intermediate signal has been observed in response to the action being performed, and
(ii) for each intermediate signal, a count of rewards that have been received for time steps for which the intermediate signal has been observed in response to the action performed at the time step,
wherein each intermediate signal in the discrete set describes a corresponding state of the environment after an action has been performed but before the reward for the performed action has been received, and
wherein each reward is a numeric value that measures a quality of the action in response to which the intermediate signal was observed;
determining, from the count data and for each action, a respective current transition probability distribution that includes a respective current transition probability for each of the intermediate signals that represents an estimate of a current likelihood that the intermediate signal will be observed if the action is performed;
determining, from the count data and for each intermediate signal, a respective reward estimate that is an estimate of a reward that will be received as a result of the intermediate signal being observed;
determining, from the respective current transition probability distributions and the respective reward estimates, a respective action score for each action; and
selecting an action to be performed in the environment based on the respective action scores.

2. The method of claim 1, wherein the environment is a content item recommendation setting, wherein the actions correspond to content items, and wherein content items corresponding to selected actions are recommended to a user in the content item recommendation setting.

3. The method of claim 1, wherein selecting an action comprises:
selecting the action with the highest action score.

4. The method of claim 1, further comprising:
receiving an indication that an intermediate signal was observed in response to the selected action being performed; and
in response, updating the count data.

5. The method of claim 1, further comprising:
receiving a reward as a result of a previous intermediate signal that was observed at an earlier time step; and
in response, updating the count data.

6. The method of claim 1, wherein, for each action and for each intermediate signal in a discrete set of intermediate signals, the count of how many times the intermediate signal has been observed in response to the action being performed is:
a windowed count that counts how many times the intermediate signal has been observed in response to the action being performed during a recent time window that includes a fixed number of most recent time steps.

7. The method of claim 6, wherein determining, from the count data and for each action, a respective current transition probability distribution that includes a respective current transition probability for each of the intermediate signals comprises:
determining the respective current transition probability for each of the intermediate signals based on a ratio of (i) the windowed count that counts how many times the intermediate signal has been observed in response to the action being performed during the recent time window to (ii) a windowed count that counts how many times the action has been performed during the recent time window.

8. The method of claim 1, wherein, for each intermediate signal, the count of rewards that have been received as a result of the intermediate signal being observed is:
a reward count that counts the rewards received for the time steps the intermediate signal has been observed in response to the action being performed during a longer time window that does not include some or all of the most recent time steps in the recent time window.

9. The method of claim 8, wherein the count data further specifies:
for each intermediate signal, a delayed count of times that the intermediate signal has been observed during the longer time window that does not include some or all of the most recent time steps in the recent time window.

10. The method of claim 9, wherein determining, from the count data and for each intermediate signal, a respective reward estimate that is an estimate of a reward that will be received as a result of the intermediate signal being observed comprises:
determining the respective reward estimate based on a ratio of (i) the reward count for the intermediate signal to (ii) the delayed count for the intermediate signal.

11. The method of claim 1, wherein determining, from the respective current transition probability distributions and the respective reward estimates, a respective action score for each action comprises:
determining the respective action scores from the respective current transition probability distributions and the respective reward estimates using a stochastic bandit technique.

12. A system comprising one or more computers and one or more storage devices storing instructions that when executed by the one or more computers cause the one or more computers to perform operations for selecting actions from a set of actions to be performed in an environment, the operations comprising, at each time step in a sequence of a plurality of time steps:
maintaining count data, the count data specifying:
(i) for each action and for each intermediate signal in a discrete set of intermediate signals, a count of how many times the intermediate signal has been observed in response to the action being performed, and
(ii) for each intermediate signal, a count of rewards that have been received for time steps for which the intermediate signal has been observed in response to the action performed at the time step,
wherein each intermediate signal in the discrete set describes a corresponding state of the environment after an action has been performed but before the reward for the performed action has been received, and
wherein each reward is a numeric value that measures a quality of the action in response to which the intermediate signal was observed;
determining, from the count data and for each action, a respective current transition probability distribution that includes a respective current transition probability for each of the intermediate signals that represents an estimate of a current likelihood that the intermediate signal will be observed if the action is performed;
determining, from the count data and for each intermediate signal, a respective reward estimate that is an estimate of a reward that will be received as a result of the intermediate signal being observed;
determining, from the respective current transition probability distributions and the respective reward estimates, a respective action score for each action; and
selecting an action to be performed in the environment based on the respective action scores.

13. The system of claim 12, wherein the environment is a content item recommendation setting, wherein the actions correspond to content items, and wherein content items corresponding to selected actions are recommended to a user in the content item recommendation setting.

14. The system of claim 12, wherein selecting an action comprises:
selecting the action with the highest action score.

15. The system of claim 12, the operations further comprising:
receiving an indication that an intermediate signal was observed in response to the selected action being performed; and
in response, updating the count data.

16. The system of claim 12, the operations further comprising:
receiving a reward that is associated with a previous intermediate signal that was observed at an earlier time step; and
in response, updating the count data.

17. The system of claim 12, wherein, for each action and for each intermediate signal in a discrete set of intermediate signals, the count of how many times the intermediate signal has been observed in response to the action being performed is:
a windowed count that counts how many times the intermediate signal has been observed in response to the action being performed during a recent time window that includes a fixed number of most recent time steps.

18. The system of claim 17, wherein determining, from the count data and for each action, a respective current transition probability distribution that includes a respective current transition probability for each of the intermediate signals comprises:
determining the respective current transition probability for each of the intermediate signals based on a ratio of (i) the windowed count that counts how many times the intermediate signal has been observed in response to the action being performed during the recent time window to (ii) a windowed count that counts how many times the action has been performed during the recent time window.

19. The system of claim 12, wherein, for each intermediate signal, the count of rewards that have been received as a result of the intermediate signal being observed is:
a reward count that counts the rewards received for the time steps the intermediate signal has been observed in response to the action being performed during a longer time window that does not include some or all of the most recent time steps in the recent time window.

20. One or more non-transitory computer-readable storage media storing instructions that when executed by one or more computers cause the one or more computers to perform operations for selecting actions from a set of actions to be performed in an environment, the operations comprising, at each time step in a sequence of a plurality of time steps:
maintaining count data, the count data specifying:
(i) for each action and for each intermediate signal in a discrete set of intermediate signals, a count of how many times the intermediate signal has been observed in response to the action being performed, and
(ii) for each intermediate signal, a count of rewards that have been received for time steps for which the intermediate signal has been observed in response to the action performed at the time step,
wherein each intermediate signal in the discrete set describes a corresponding state of the environment after an action has been performed but before the reward for the performed action has been received, and
wherein each reward is a numeric value that measures a quality of the action in response to which the intermediate signal was observed;
determining, from the count data and for each action, a respective current transition probability distribution that includes a respective current transition probability for each of the intermediate signals that represents an estimate of a current likelihood that the intermediate signal will be observed if the action is performed;
determining, from the count data and for each intermediate signal, a respective reward estimate that is an estimate of a reward that will be received as a result of the intermediate signal being observed;
determining, from the respective current transition probability distributions and the respective reward estimates, a respective action score for each action; and
selecting an action to be performed in the environment based on the respective action scores.
